(19) United States
(12) Patent Application Publication
(10) Pub. No.: US 2026/0122595 A1
(43) Pub. Date: Apr. 30, 2026

(54) SWITCHING BETWEEN INTERNET-PROTOCOL-BASED AND NON-INTERNET-PROTOCOL-BASED DATA DELIVERY

(71) Applicant: T-Mobile USA, Inc., Bellevue, WA (US)

(72) Inventors: Anbalagan Elumalai, Issaquah, WA (US); Paul Marvin Lim Chy, Snohomish, WA (US); Anupama Malireddy, Sammamish, WA (US)

(21) Appl. No.: 18/933,945

(22) Filed: Oct. 31, 2024

(51) Int. Cl. H04W 60/04; H04W 24/08; H04W 60/06

(52) U.S. Cl. CPC H04W 60/04; H04W 24/08; H04W 60/06

(57) ABSTRACT

Techniques and systems are disclosed for managing the registration and communication of Internet-of-Things (IoT) devices with a Lightweight M2M (LwM2M) server using both Internet-Protocol (IP) and non-IP data bearers. The system registers the IoT client device with the LwM2M server using an IP data bearer to enable communication over the IP data bearer. The system monitors for a first condition, which includes the reception of a Monitoring Event (MONTE) event or a failure to receive a registration update message within a period corresponding to the registration lifetime of the IoT client device. Upon determining that the first condition is satisfied, the system evaluates device or network data to determine if a second condition is met and, if so, transmits a communication to the IoT client device instructing it to register with the LwM2M server using the non-IP data bearer.

### BACKGROUND

Internet-of-Things (IoT) devices often communicate using Internet-Protocol-(IP)-based communication to benefit from the increased speed and control capabilities it provides. In some cases, however, non-IP Data Delivery (NIDD) offers several benefits over IP-based communication. For example, NIDD are designed to minimize overhead, making them ideal for devices with limited processing power, memory, and battery life or in network constrained applications (e.g., where signal strength is weak or a heavy amount of network traffic is present). NIDD can accordingly be less costly to users than IP-based communication. Additionally, NIDD can provide enhanced security by reducing the attack surface; since it bypasses the traditional IP stack, it eliminates many of the vulnerabilities associated with IP-based communication, such as IP spoofing and Distributed Denial-of-Service (DDoS) attacks.

### BRIEF DESCRIPTION OF THE DRAWINGS

Detailed descriptions of implementations of the present invention will be described and explained through the use of the accompanying drawings.

FIG. 1 illustrates a wireless communications system that can implement aspects of the present technology.

FIG. 2 illustrates 5G core NFs that can implement aspects of the present technology.

FIG. 3 illustrates an example IoT device in which aspects of the present technology can be implemented.

FIG. 4 illustrates an example IoT service enablement platform in which aspects of the present technology can be implemented.

FIG. 5 illustrates an example architecture for IP-based communication in accordance with aspects of the present technology.

FIG. 6 illustrates an example architecture for NIDD in accordance with aspects of the present technology.

FIG. 7 illustrates an example method for switching between IP-based and non-IP-based data delivery in accordance with aspects of the present technology.

FIG. 8 is a block diagram that illustrates an example of a computing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Applications for IoT devices have continued to increase to improve industrial and residential operations. For example, IoT devices are deployed in residences to control and manage aspects of the residence. In industry, IoT devices are used to optimize manufacturing processes, improve supply chain management, and enhance predictive maintenance, thereby reducing downtime and operational costs. In agriculture, IoT devices monitor soil conditions, weather patterns, and crop health, enabling precision farming practices that increase yield and resource efficiency. IoT devices are deployed in smart cities to manage traffic flow, reduce energy consumption, and improve public safety. In the shipping industry, IoT devices are revolutionizing fleet management, cargo tracking, and port operations. Accordingly, IoT devices continue to become more prevalent. With this increase in the number of IoT devices deployed in an environment, wireless networks are becoming more congested with IoT device traffic.

IoT devices can be provisioned to communicate using both IP-based communication and NIDD at different times. IP-based communication can utilize the user plane to communicate data over an IP data bearer, while NIDD can communicate data on the control plane through a non-IP-based data bearer. IP-based communication can have various advantages over NIDD. For example, IP-based communication delivery data with improved latency when sufficient network resources are available. IP-based communication can also leverage various security procedures, such as Transport Layer Security (TLS) protocols, that improve the security of IP-based communications. In some cases, however, NIDD may have significant advantages over IP-based communication. NIDD can be communicated with fewer network resources than IP-based communication on account that NIDD does not require IP-specific header information and thus can be provided to the user at a lower cost than IP-based communication. Similarly, NIDD can be provided with more limited network coverage than IP-based communication (e.g., in remote locations, such as those in which IoT devices are deployed for agricultural or shipping applications). Accordingly, device performance and network congestion can be improved by enabling IoT devices to communicate using both IP-based communication and NIDD.

While an IoT device can communicate using both IP-based and non-IP-based communication (e.g., NIDD), service enablement platforms that manage IoT devices can only communicate with the IoT device over one of these channels at a given time (e.g., IP-based communication or non-IP-based communication). For example, the service enablement platform can communicate with the IoT device using a Lightweight Machine-to-Machine (LwM2M) protocol. The service enablement platform can register one or more devices to be managed by the platform. When registered, a single communication channel can be specified for communicating with the IoT device, and the service enablement platform can maintain a single registration for each IoT device. To switch between communication channels, the IoT device and the service enablement platform communicate to adjust the registration of the device to reflect the new communication channel. For example, the IoT device and the service enablement platform can engage in a Datagram Transport Layer Security (DTLS) communication to adjust the registration. This communication, however, may be difficult to complete when network coverage is limited or the network is congested. Thus, current IoT devices may struggle to switch between and leverage the advantages of different communication channels.

To address this problem and others, the present technology provides a mechanism for switching between IP-based and non-IP-based data delivery. The IoT service enablement platform can include logic that causes the IoT device to switch between IP-based data delivery and non-IP-based data delivery when a condition is satisfied that indicates that non-IP-based data delivery may be beneficial for the IoT device. Such conditions might occur when the network is too congested to efficiently provide IP data delivery or when limited network coverage is available. The service enablement platform can utilize one or more communications from the IoT device or an element of the network to determine if the condition is satisfied. For example, the service enablement platform can check communication logs (e.g., DTLS communication logs) to determine if one or more previous communications from the IoT device has previously failed to be completed. Alternatively or additionally, the service enablement platform can check the signal strength of the IoT device’s connection to the network (e.g., indicated in an LwM2M object registered to the IoT device) to determine if it meets a signal strength threshold. If the signal strength is weak or previous communications from the IoT device have failed, this could indicate that non-IP-based communication may be more efficient or effective than IP-based communications. In this case, the IoT service enablement platform can transmit a request to cause the IoT device to communicate with the IoT service enablement platform using the non-IP-based communication.

The IoT service enablement platform can transmit this request using the LwM2M protocol. For example, the IoT service enablement platform can initiate the change to the non-IP-based communication by updating the access point name (APN) connection profile LwM2M object registered to the IoT device to reflect the non-IP-based communication for subsequent communications with the IoT service enablement platform. The IoT service enablement platform can similarly initiate a change from the IP-based communication to the non-IP-based communication by updating the APN connection profile LwM2M object registered to the IoT device to reflect the IP-based communication for subsequent communications with the IoT service enablement platform.

The IoT service enablement platform can be triggered to check if the condition to switch from the IP-based communication to the non-IP-based communication is satisfied by monitoring communications on the network. For example, the IoT device can continue to send registration refresh communications to maintain the registration of the IoT device with the service enablement platform. If a registration refresh message is not received in an amount of time for which the registration is maintained without refresh, referred to sometimes as the registration lifetime, this might indicate that the IoT device is having a difficulty communicating using the current communication type (e.g., IP-based communication). Alternatively, the IoT service enablement platform can receive Monitoring Events (MONTE) events that indicate one or more characteristics about the IoT device that may indicate that the IoT device could benefit from a change of communication type. In response to failing to receive a refresh of the current registration of the IoT device or the reception of a MONTE event, the IoT service enablement platform can check the communication logs, the LwM2M objects registered to the IoT device, or other network communications to determine if the IoT device would benefit from switching to the non-IP-based communication (e.g., because the IoT device has a weak connection to the network or there is large amounts of network congestion). If so, the IoT device can initiate a switch to the non-IP-based communication.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

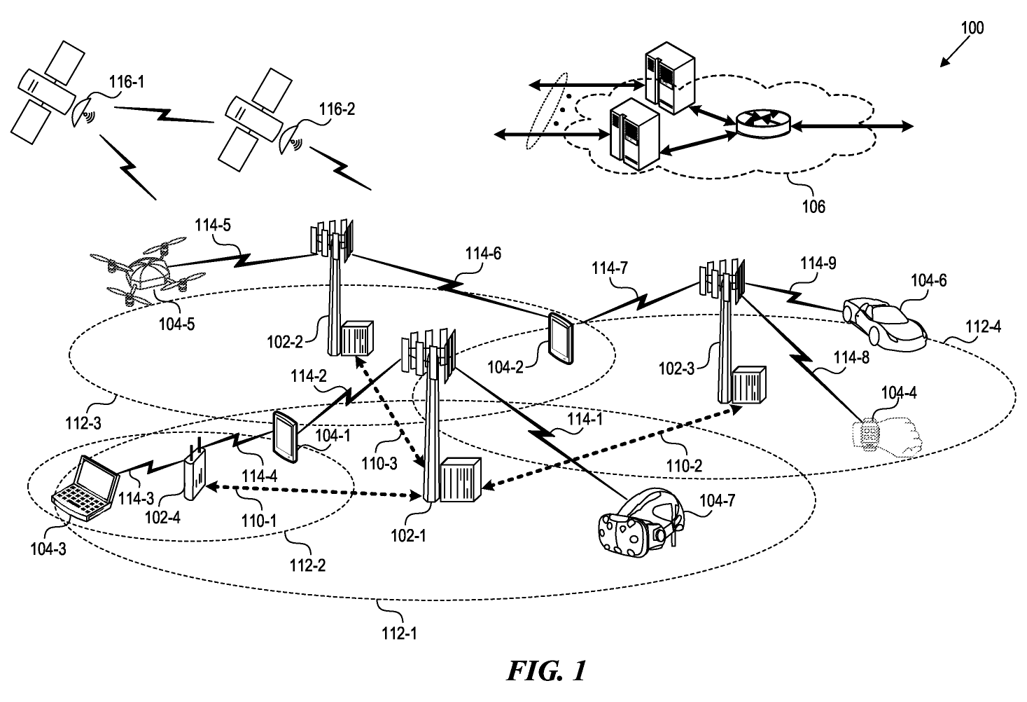

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, IP connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., IoT, mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core NFs

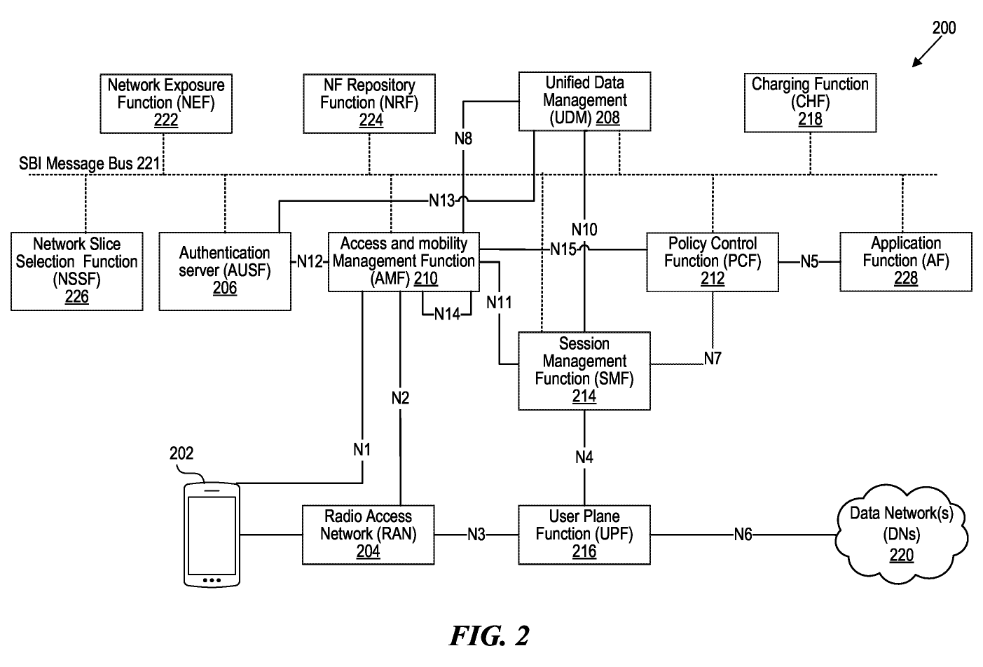

FIG. 2 illustrates 5G core NFs 200 that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example IoT Device

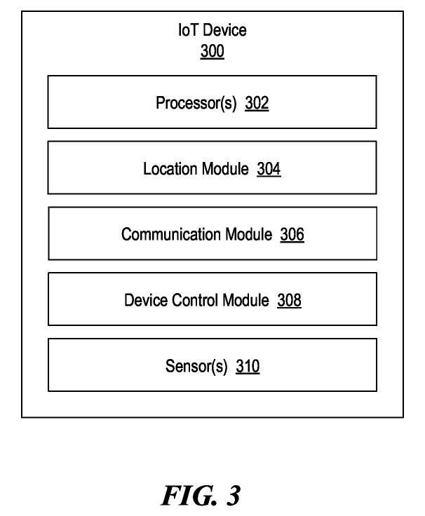

FIG. 3 illustrates an example IoT device 300 in which aspects of the present technology can be implemented. The IoT device 300 can take any suitable physical form. For example, the IoT device 300 can include wearable devices, smart home devices, industrial devices, connected vehicles, healthcare devices, agricultural devices, smart city devices, environmental sensors, or the like. In aspects, the IoT device 300 can be implemented in an industrial environment in which the IoT device 300 provides monitoring or tracking of commercial activities. In some cases, the IoT device 300 can operate at least part of the time within remote areas with limited coverage from cellular networks. For example, the IoT device 300 can be placed on cargo shipped overseas, in a rural area such as an agricultural farm or solar farm, or in any other remote location.

The IoT device 300 includes at least one processor 302. The processor 302 can execute machine-readable instructions to manage and execute all computational tasks performed by the IoT device 300. For example, the various modules of the IoT device 300 can include machine-readable instructions executed by the processor 302. The processor 302 can be located at the IoT device 300 or remotely coupled with the IoT device 300. In aspects, the processor 302 can be a central processor or an application-specific processor.

The IoT device 300 includes a location module 304 responsible for providing location estimates of the IoT device 300. The location module 304 can include machine-readable instructions executable by the processor 302. The location module 304 can determine the location of the IoT device 300 using any appropriate mechanism. For example, the location module 304 can implement a Global Navigation Satellite System (GNSS) to determine device location through signals received from one or more satellites. In other cases, the location module 304 can determine its location through triangulation from proximate devices (e.g., base stations, other IoT devices, or other wireless devices). The location module 304 can continually track the location of the IoT device 300 or determine the location of the IoT device 300 at different times (e.g., at predetermined intervals or in response to collecting data that is to be reported with a location estimate). The location module 304 can determine the latitude, longitude, or elevation of the IoT device 300. The location module 304 can similarly determine the speed of the IoT device 300 based on differences in location estimates determined by the location module 304. Moreover, the location module 304 can determine a timestamp that corresponds with the location estimate. In this way, the location module 304 can ensure that the location information is accurate and up to date.

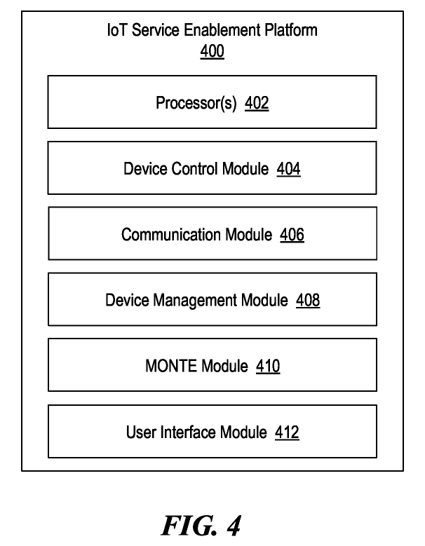

The IoT device 300 includes a communication module 306 implemented through machine-readable instructions executable by the processor 302. The communication module 306 can be used to communicate data collected by the IoT device 300 to an owner or manager of the IoT device 300—for example, if the IoT device 300 can report collected data or operational data to the owner or manager of the IoT device 300 using a wireless communication network. Similarly, the communication module 306 can receive commands from an LwM2M server (discussed with greater detail with respect to FIG. 4) that manages the IoT device 300. In aspects, the communication module 306 can communicate using any wireless communication technology. For example, the communication module 306 can communicate using either an IP data bearer or a non-IP data bearer (e.g., NIDD). The communication module 306 can maintain multiple data bearers (e.g., having different APNs) at a single time. The LwM2M server may only register and manage the IoT device 300 over a single data bearer at any given time, however.

The communication module 306 can communicate using any communication protocol. In aspects, the communication module 306 can communicate using an LwM2M protocol, which provides a structured protocol for managing multiple IoT devices and their connectivity. For example, the LwM2M protocol can organize device data into a hierarchical structure of objects, instances, and resources. Each resource can represent a specific piece of data or functionality, such as sensor readings or control commands. The communication module 306 can use this structure to manage and exchange data efficiently. For example, the communication module 306 can periodically send data to the platform, such as sensor readings, status updates, or alerts. The communication module 306 can further provide encryption, authentication, and integrity protection for the data exchanged, safeguarding it from unauthorized access and tampering.

The communication module 306 can issue registration requests to the LwM2M server to register the IoT device 300 with the server and enable the IoT device 300 to communicate with and be managed by the LwM2M server. To register with the LwM2M server, the communication module 306 can communicate a registration request to the LwM2M server (e.g., using an active data bearer). The registration request can include the endpoint name, supported LwM2M objects, or registration lifetime of the IoT device 300. The registration request can indicate (e.g., expressly or through the communication occurring over the active data bearer) that communications between the IoT device 300 and the LwM2M server are to take place over the active data bearer. In aspects, an IoT device 300 can be registered with the LwM2M server over a particular server based on the active APN indicated in the APN connection profile.

The LwM2M server can receive the registration request and register the IoT device 300 to enable communication with and monitoring of the IoT device 300. The registration can indicate that the IoT device 300 is registered with the LwM2M server using the active data bearer (e.g., IP or non-IP) such that communication between the IoT device 300 and the LwM2M server occurs using the active data bearer. The LwM2M server can further store other information related to the IoT device 300 (e.g., in LwM2M objects registered to the IoT device 300). For example, the LwM2M server can store information about the connectivity of the IoT device 300 (e.g., a signal strength of the IoT device 300 with the telecommunications network on which it is communicating with the LwM2M server or the APN connection profile) or any other information related to the IoT device 300 or its connection with the network or the LwM2M server.

The LwM2M server can maintain the registration of the IoT device 300 in accordance with the lifetime of the registration communicated in the registration request. For example, the lifetime can indicate a period of time for which the registration is maintained without an additional registration update or reregistration. Thus, the LwM2M server can de-register and cease management of the IoT device 300 in response to the expiration of the registration lifetime without an additional registration update or reregistration. Once the IoT device 300 is de-registered from the LwM2M server, the IoT device 300 can reregister with the LwM2M server using a similar process to that described above. Alternatively, to maintain the registration of the IoT device 300, the IoT device 300 (e.g., through the communication module 306) can transmit registration update communications (e.g., separate from or within other communications, such as communications providing sensor data) using the active data bearer and update the LwM2M server with any changes in its status or configuration, including any changes related to its connection to the wireless network.

Once the IoT device 300 is registered with the LwM2M server, the IoT device 300 and the LwM2M server can communicate to manage the IoT device 300. For example, the IoT device 502 can transmit sensor data, device data, connectivity data, or any other data to the LwM2M server 504 using the active data bearer. The LwM2M can receive the data communicated over the active data bearer and perform various operations, such as storing, analyzing, or forwarding the data. For example, the LwM2M server can store the data within resources of LwM2M objects registered to the IoT device, forward the data to one or more other applications monitoring the data from the IoT device 300, or analyze the data to determine operations to manage the IoT device 300 (e.g., instructing the IoT device 300 to reregister with a different data bearer).

The IoT device 300 includes a device control module 308 that can control operation of the IoT device 300. In aspects, the device control module 308 is used to perform operations at the IoT device 300 based on signaling received from the LwM2M server through the communication module 306. For example, the communication module 306 can receive commands from the LwM2M server to switch from an IP data bearer to a non-IP data bearer, or vice versa. In aspects, the commands can be communicated using resources of LwM2M objects. For example, an APN connection profile LwM2M object (Object ID: 11) can be used to control the active data bearer on which the IoT device 300 communicates. Accordingly, the device control module 308 can include logic that can switch the IoT device 300 between communicating using the different data bearers. The communication module 306 can switch between the multiple data bearers by altering an LwM2M APN connection profile object indicating an active APN connection profile of the IoT device 300 to reflect the active data bearer (e.g., IP-based or non-IP-based) or activating communication components (e.g., software/modems) used to communicate on the active data bearer and deactivating communication components used to communicate on the inactive data bearer.

In general, the communication module 306 can receive read, write, or execute commands associated with a resource of an LwM2M object. A read command can cause the device control module 308 to retrieve the current value of a resource from an LwM2M object. When the LwM2M server issues a read command, the IoT device 300 responds with the requested data. The read command can be used to monitor the status or configuration of the IoT device 300. The write command can cause the device control module 308 to update the value of a resource within an LwM2M object. Write operations can be used by the LwM2M server to configure or control the IoT device 300 remotely. When a write command is issued, the device control module 308 can update the specified resource with the new value provided by the LwM2M server. The execute command can be used to trigger a specific action or operation on the IoT device 300 by the device control module 308. Unlike read and write commands, which deal with data values, the execute command can initiate a predefined function or procedure on the IoT device 300. When the LwM2M server issues an execute command, the device control module can perform the corresponding action.

The IoT device 300 includes one or more sensors 310 used to collect data to provide functionality to the IoT device 300. For example, the sensors 310 can include any sensor that can collect data to be reported by the IoT device. As a specific example, the sensors 310 can include a temperature sensor when the IoT device 300 is used to monitor the temperature of an environment of the IoT device 300. As non-limiting examples, the sensors 310 can include temperature sensors, humidity sensors, pressure sensors, proximity sensors, light sensors, motion sensors, accelerometers, gyroscopes, magnetometers, gas sensors, sound sensors, image sensors, vibration sensors, flow sensors, and so on. The data collected by the sensors 310 can be reported to an owner or manager of the IoT device 300 (e.g., at the LwM2M server) through the communication module 306.

### Example LwM2M Server

FIG. 4 illustrates an example LwM2M server 400 in which aspects of the present technology can be implemented. The LwM2M server 400 can be hosted on a server of a provider of the wireless network. Thus, the LwM2M server 400 can be a service provided to users who connect their IoT devices using the wireless network. In this way, the users can manage their IoT devices and remotely receive data from their IoT devices over the wireless network.

The LwM2M server 400 includes at least one processor 402. The processor 402 can execute machine-readable instructions to manage and execute all computational tasks performed by the LwM2M server 400. For example, the various modules of the LwM2M server 400 can include machine-readable instructions executed by the processor 402. The processor 402 can be located at the LwM2M server 400 or remotely coupled with the LwM2M server 400. In aspects, the processor 402 can be a central processor or an application-specific processor.

The LwM2M server 400 includes a device control module 404 responsible for receiving and storing data from one or more IoT devices managed by the service enablement platform (e.g., IoT device 300 illustrated in FIG. 3). For example, the device control module 404 can receive sensor data collected by the IoT device and communicated over the wireless network by the IoT device. The device control module 404 can store data from the IoT device in relation to a registration of the IoT device with the LwM2M server 400.

The LwM2M server 400 includes a communication module 406 that can communicate with the IoT device over the wireless network. The communication module 406 can communicate using any communication protocol. In aspects, the communication module 406 can communicate using the LwM2M protocol, which can be used to manage multiple IoT devices. The communication module 406 can communicate data in accordance with a particular format. For example, the communication module 406 can receive and transmit commands within resources of LwM2M objects.

The LwM2M server 400 includes a device management module 408 that can be used to register the IoT device with the LwM2M server 400. For example, the device management module 408 can receive a registration request from the IoT device and register the IoT device with the LwM2M server 400 based on the request. Once registered, the device management module 408 can update the registration or de-register the device in response to one or more events. For example, in response to registration updates from the IoT device, the device management module 408 can refresh the registration (e.g., restart the lifetime of the registration) of the IoT device. The device management module 408 can similarly update any aspects of the registration if the registration update indicates to do so. If no registration update is received in the lifetime of the registration, the device management module 408 can de-register the IoT device. In this case, the device management module 408 can further analyze data about the device or the device’s connection to the network to determine if a trigger to the IoT device to switch the active data bearer would improve communication with the IoT device. The device management module 408 can similarly de-register the IoT device when a switch of the active data bearer is triggered even if the lifetime of the registration has not expired. Once registered, the device control module 404 can store data received from the IoT device in relation to the registration of the device (e.g., in resources of LwM2M objects).

The device management module 408 can issue commands to control operation of the IoT devices using the communication module 406. For example, the device management module 408 can issue requests to cause the IoT device to switch from an active data bearer to a different data bearer (e.g., from an IP data bearer to a non-IP data bearer, or vice versa). As a specific example, the LwM2M server 400 can initiate a change from the active data bearer to an inactive data bearer by updating the APN connection profile LwM2M object registered to the IoT device to reflect the inactive data bearer. This change can be made directly by the LwM2M server 400 or through a request to the IoT device to update the APN connection profile. As a result of the request, the IoT device can reregister with the LwM2M server 400 using the formerly inactive and now active data bearer. The new registration can indicate the now active data bearer as the data bearer used for communication.

The device management module 408 can analyze data received from the IoT devices to determine which operations are needed to control the IoT devices. For example, the device management module 408 can store, in association with the IoT devices managed by the LwM2M server 400, data about the IoT device or its connection to the network to determine if the IoT device would benefit from a switch of the active data bearer. In aspects, the LwM2M server can determine a signal strength between the network on which the IoT device is communicating with the LwM2M server 400 (e.g., from an LwM2M object associated with the device (Object ID: 4 or 5) and having a resource indicating the signal strength). Alternatively or additionally, the LwM2M server 400 can retrieve records of one or more previous communications (e.g., DTLS communications) from the IoT device to determine if one or more previous communications from the IoT device have failed. A weak network signal strength or previous failed communications can signal that the IoT device has inadequate network resources for efficient IP-based communication and indicate that the IoT device would benefit from a switch to the non-IP data bearer. Thus, the LwM2M server 400 can trigger a switch to the non-IP data bearer when these conditions are satisfied. The commands can be communicated using resources of LwM2M objects, such as the LwM2M device object. For example, the LwM2M server 400 can update the APN connection profile LwM2M object registered to the IoT device to reflect the non-IP data bearer. The device management module 408 can similarly trigger a switch of the IoT device from the non-IP data bearer to the IP data bearer.

The device management module 408 can receive MONTE events received using a MONTE module 410. The MONTE module 410 can receive MONTE events from the Service Capability Exposure Function (SCEF)/NEF of the network to determine appropriate action to control operation of the IoT device. In aspects, the MONTE events can be detected from monitoring by various elements of the network, such as the Mobility Management Entity (MME), the HSS/Home Location Register (HLR), or the Serving Gateway (SGW), and the events can be triggered by the SCEF/NEF. The MONTE events can indicate characteristics about the connection of the IoT device to the network. For example, the MONTE events can include a loss of connectivity event (e.g., LOSS_OF_CONNECTIVITY), a communication failure event (e.g., COMMUNICATION_FAILURE), a UE reachability event (e.g., UE_REACHABILITY), an availability after downlink data notification (DDN) failure event (e.g., AVAILABILITY_AFTER_DDN_FAILURE), a roaming status event (e.g., ROAMING_STATUS), a location reporting event (e.g., LOCATION REPORTING), or a Packet Data Network (PDN) connectivity event (e.g., PDN_CONNECTIVITY_STATUS).

The loss of connectivity event can be triggered when an IoT device loses its connection to the network. The loss of connectivity event can indicate that the IoT device is no longer reachable for communication. The event report can include information about the IoT device’s identity, the time of the connectivity loss, and any relevant network conditions that may have contributed to the loss of connectivity. In some cases, this event can be used to determine that there are limited network resources at the IoT device’s location and a switch to less-intensive non-IP communication is appropriate.

The UE reachability event can be triggered when the reachability status of an IoT device changes. This event can indicate whether the IoT device is reachable or unreachable for communication. The event report can include information about the IoT device’s identity, the time of the status change, and the new reachability status. In some cases, this event can be used to determine that there are limited network resources at the IoT device’s location and a switch to less-intensive non-IP communication is appropriate.

This location reporting event can be triggered when there is a significant change in the location of an IoT device (e.g., greater than a reporting threshold). This event can provide information about the IoT device’s new location, such as the cell ID or tracking area. The event report can include the IoT device’s identity, the time of the location change, and the new location details. The location event can be used to signal that the location of the device has changed, and thus the device may be experiencing different network conditions. Thus, this event can trigger the LwM2M server to analyze data to determine if the IoT device would benefit from a switch to a different data bearer.

This roaming status event can be triggered when the roaming status of an IoT device changes. The event can indicate whether the IoT device has started or stopped roaming. The event report can include information about the IoT device’s identity, the time of the status change, and the new roaming status. This event is useful for managing roaming agreements and ensuring compliance with roaming policies.

The communication failure event can be triggered when there is a failure in communication with an IoT device. It can indicate that an attempt to communicate with the IoT device has failed. The event report can include information about the IoT device’s identity, the time of the failure, and details about the nature of the failure (e.g., signaling failure, data transmission failure). This event can be used for alerting the network that a different data bearer may provide more efficient or robust communication.

The availability after DDN failure event can be triggered when an IoT device becomes available after a DDN failure. The event can indicate that the IoT device, which was previously unreachable for DL data delivery, is now available again. The event report can include information about the IoT device’s identity, the time of the availability change, and any relevant network conditions. This event can indicate that the network conditions have changed and thus a different data bearer may be appropriate.

The PDN connectivity event can be triggered when the status of a PDN connection is changed. The event can indicate that a new PDN is available to the IoT device and can be used to communicate data or a previously available PDN is disconnected or modified. The event report can include the IoT device’s identity, PDN connection details (e.g., APN or IP address), event type (e.g., establishment, modification, or release), a timestamp of the event, and QoS parameters. The event can be used to indicate that the configuration of PDNs available to the IoT device has changed, and thus a different data bearer may be appropriate for communication.

Given that the MONTE events can provide information about the connection between the IoT device and the network, the MONTE events can be used to determine that the IoT device may benefit from a switch to a different data bearer. Accordingly, the MONTE events can trigger the device management module 408 to initiate a switch of the active data bearer or cause the device management module 408 to analyze data, such as the signal strength or the previous communication logs, to determine if the IoT device can benefit from a switch of the current data bearer. If so, a switch can be initiated.

The user (or owner/manager) of the IoT device can view operations of their IoT device through the LwM2M server 400. For example, the LwM2M server 400 includes a user interface module 412 that enables users of the IoT device to control operation of the device and view data provided by the IoT device. In aspects, the user interface module 412 can present data received from the IoT device to users of the IoT device to enable these users to benefit from and manage their device. For example, the user can view sensor data collected by their IoT device and communicated to the LwM2M server 400.

### Example IP-Based Communication Architecture

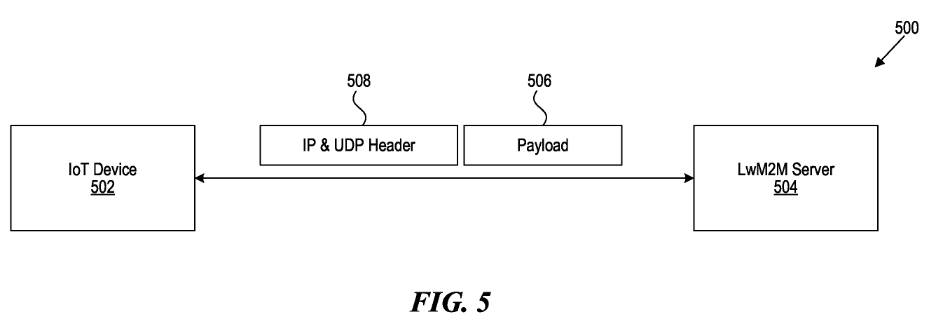

FIG. 5 illustrates an example architecture 500 for IP-based communication in accordance with aspects of the present technology. In particular, the architecture 500 illustrates how an IoT device 502 and an LwM2M server 504 (e.g., or any other Service Capability Server (SCS) or Application Server (AS)) communicate a payload 506 over a wireless telecommunications network. The payload 506 can be communicated across the user plane of the wireless telecommunications in compliance with any protocol of the IP suite, including the Transmission Control Protocol (TCP) or the User Datagram Protocol (UDP).

To enable communication between the IoT device 502 and the LwM2M server 504 on the telecommunications network, the IoT device 502 attaches to the telecommunications network. The IoT device 502 can attach to the network by communicating with a base station (e.g., an eNB or gNB) providing network coverage to an area in which the IoT device 502 is located and the core network. Once the IoT device 502 is attached to the network, the IoT device 502 can be assigned an IP address (e.g., by the network’s DHCP (Dynamic Host Configuration Protocol) server or through a static IP configuration) that can be used for subsequent IP-based communication. The communication can take place through an IP data bearer, which is a logical channel that carries IP packets between the IoT device 502 and the network. This IP data bearer can be established through one or more core network elements (e.g., a packet gateway (PGW) or UPF) of the telecommunication network. Given that the communication is IP-based, the communication can have specific QoS parameters. Thus, the IP-based communication can communicate data with a larger bandwidth, reduced latency, reduced packet loss, and so on, making it appropriate for some critical data transmission situations (e.g., real-time video monitoring, real-time signaling, or in situations with high data loads and sufficient network coverage).

Once the IP data bearer is established, data can be communicated between the IoT device 502 and any SCS/AS through the IP data bearer. For example, the IoT device 502 can communicate data (e.g., sensor data or control signaling) as the payload 506 through the IP data bearer. The payload 506 is encapsulated in IP packets that include a header 508. These packets can be configured in accordance with various protocols, such as UDP or TCP. For example, the header 508 can include fields that identify the source and destination of the packet, indicate the packet size or configuration (e.g., window size), include security information, or include other information used for data transmission, reliability, and flow control. In some cases, the IP packets are encrypted (e.g., using protocols such as TLS or DTLS). Once packetized, the IP packets can be transmitted over the user plane of the telecommunications network using the IP data bearer.

To communicate with and be managed by the LwM2M server 504, the IoT device 502 must register with the LwM2M server 504. To register with the LwM2M server 504, the IoT device 502 can communicate with the LwM2M server 504 (e.g., using the IP data bearer). For example, the IoT device 502 can discover the IP address of the LwM2M server through pre-configuration, Domain Name System (DNS) lookup, or a bootstrap server and send a registration request to the LwM2M server 504. In response to the registration request, the IoT device 502 can be registered on the LwM2M server 504 using the IP data bearer such that further communication takes place over the IP data bearer. The LwM2M server 504 can maintain the registration of the IoT device 502 in accordance with the lifetime of the registration communicated in the registration request and any subsequent registration updates.

Once the IoT device 502 is registered with the LwM2M server 504, the IoT device 502 and the LwM2M server 504 can communicate to manage the IoT device 502. For example, the IoT device 502 can transmit sensor data, device data, connectivity data, or any other data to the LwM2M server 504 using the IP data bearer. The LwM2M can receive the IP packets communicated over the IP data bearer and perform various operations, such as storing, analyzing, or forwarding the data. For example, the LwM2M server 504 can store the data within resources of LwM2M objects registered to the IoT device 502, forward the data to one or more other applications monitoring the data from the IoT device 502, or analyze the data to determine operations to manage the IoT device 502 (e.g., instructing the IoT device 502 to reregister with a different data bearer).

### Example NIDD Architecture

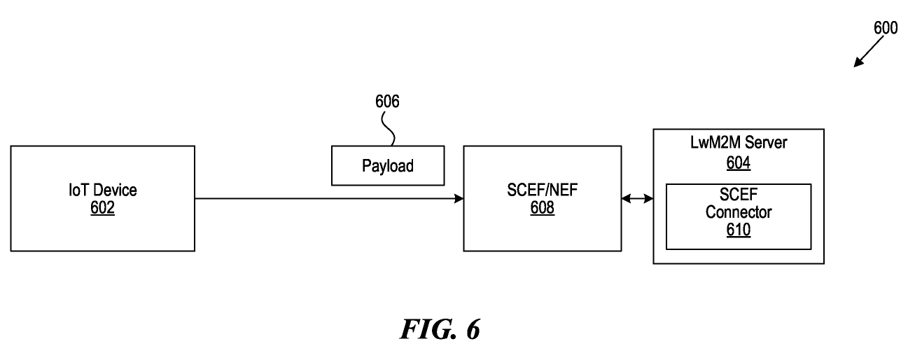

FIG. 6 illustrates an example architecture 600 for NIDD in accordance with aspects of the present technology. NIDD enables data to be communicated without traditional IP-based protocols. NIDD utilizes a SCEF/NEF 608 to communicate data between the IoT device 602 and a SCS/AS such as the LwM2M server 604. In doing so, a payload 606 can be communicated through the control plane of the telecommunications network without using traditional IP-based protocols. The payload 606 can be transmitted without headers required for IP-based communication, thereby reducing the bandwidth required by NIDD in comparison to IP-based communication. Accordingly, NIDD can be provided at a lower cost compared to IP-based communication. Moreover, NIDD can be used to provide reliable communication even during high congestion events or when limited network coverage is available, avoid certain IP-based attacks, such as DDoS attacks, and reduce the utilization of limited IP addresses (e.g., particularly in IPv4 applications).

The SCEF/NEF 608 can facilitate communication between the IoT device 602 and the LwM2M server 604 through the control plane. A non-IP data bearer can be established that uses the SCEF/NEF 608 instead of the PGW or UPF, as in IP-based communication. The SCEF/NEF 608 can include a representational state transfer (REST) application program interface (API) that can reach interfaces within the LwM2M server 604 (e.g., or any other SCS/AS) to communicate data between the IoT device 602 and the LwM2M server 604. The LwM2M server 604, or any other SCS/AS, can include a SCEF/NEF connector 610 that can connect with the SCEF/NEF 608 to receive or transmit data. For example, the SCEF/NEF 608 can deliver the payload 606 through the REST API to the SCEF/NEF connector 610.

Once the non-IP data bearer is set up to communicate data on the control plane of the telecommunications network using the SCEF/NEF 608, the IoT device 602 and LwM2M server 604 can communicate with one another on the non-IP data bearer. For example, the IoT device 602 can issue a registration request to register the IoT device 602 with the LwM2M server 604 using the non-IP data bearer (e.g., through the SCEF/NEF 608). The LwM2M server 604 can then register the IoT device 602 with the LwM2M server 604 so that subsequent communications, such as registration refresh messages, sensor data, and control data, can be transmitted through the non-IP data bearer while the registration is maintained.

### Switching Between IP-Based and Non-IP-Based Data Delivery

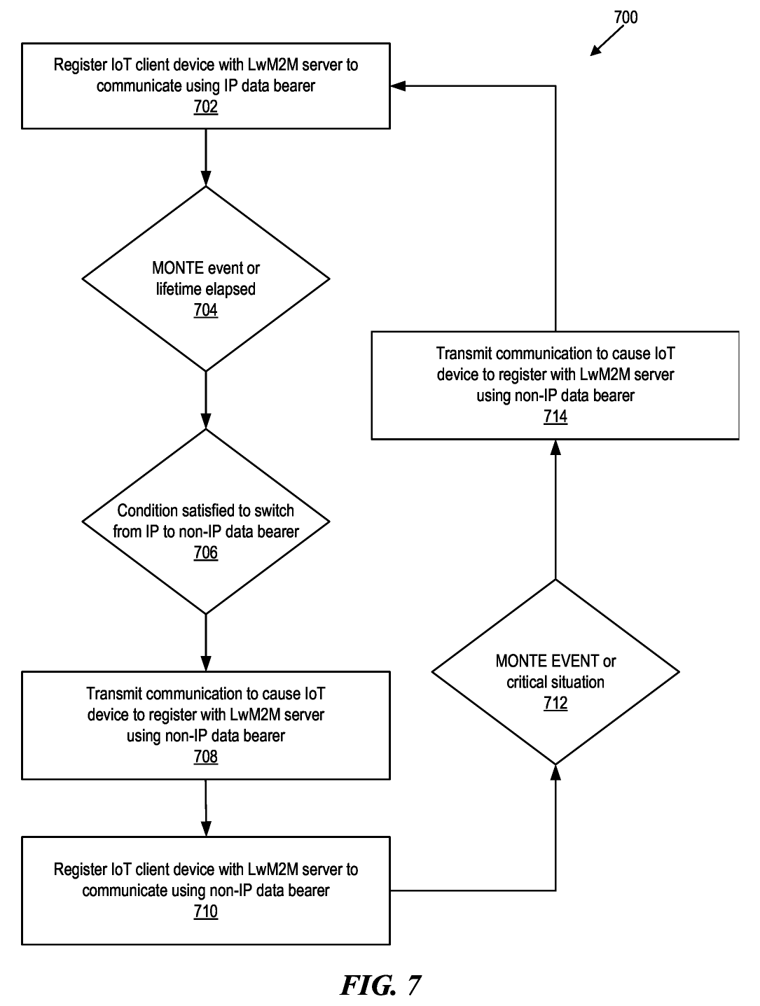

FIG. 7 illustrates an example method 700 for switching between IP-based and non-IP-based data delivery. Although illustrated in a particular configuration, one or more operations of the method 700 may be omitted, repeated, or reorganized. Additionally, the method 700 may include other operations not illustrated in FIG. 7—for example, operations detailed in one or more other methods described herein. In aspects, the operations are performed by an LwM2M server responsible for managing operations of an IoT device.

At 702, the IoT device is registered with the LwM2M server such that communication between the IoT device and the LwM2M server takes place over an IP data bearer. The IoT device can be capable of communicating using both an IP data bearer and a non-IP data bearer, as discussed above. The LwM2M server, however, may be limited as to registering the IoT device with a single data bearer (e.g., either IP or non-IP) that acts as the data bearer for communication between the IoT device and the LwM2M server. The IoT device can register with the LwM2M server by transmitting a registration request using the IP data bearer or the non-IP data bearer. If the IoT device is authorized to register with the LwM2M server, the request can be granted and the LwM2M server can register the IoT device such that it is managed by the LwM2M server. This management can include receiving data (e.g., control data or sensor data) from the IoT device, transmitting data to the IoT device, or causing one or more operations at the IoT device. Communication between the IoT device and the LwM2M server can take place in accordance with the LwM2M protocol. For example, data and other communications can take the form of resources within LwM2M objects defined for the IoT device.

Given that the LwM2M server may only be able to register a single data bearer for communication with the IoT device, the active data bearer can be indicated in the registration request to dictate the data bearer used for subsequent communication with the IoT device. The active data bearer can be identified explicitly in the registration request (e.g., by identifying one or more characteristics of the active data bearer, such as the APN) or based on that data bearer being used to communicate the registration request. At 702, the registration request indicates that the active data bearer is the IP data bearer, and thus the IoT device is registered with the LwM2M server using the IP data bearer such that it is used for subsequent communication while the registration is maintained. For example, the IP data bearer can be used for communications of sensor data from the IoT device or control data between the IoT device and the LwM2M platform.

The registration request can include additional information relating to the registration, such as the LwM2M objects enabled for the IoT device or the lifetime of the registration. The LwM2M objects enabled for the IoT device can define the type of data communicated between the IoT device and the LwM2M server (e.g., what sensor data or control data is to be registered with and managed for the IoT device) or the operations that can be performed on the IoT device. The lifetime of the registration can indicate the period of time for which the IoT device will remain registered with the LwM2M platform if no additional registration updates are transmitted to the LwM2M server. If the lifetime registration expires without an additional registration update, however, the LwM2M server can de-register the IoT device.

At 704, it is determined whether a MONTE event is received or the lifetime of the registration has elapsed without reception of a registration update from the IoT device to satisfy a first condition sufficient to trigger the analysis of data from the IoT device or the network to determine if a switch from the IP data bearer to the non-IP data bearer. In aspects, this condition is utilized to determine if a change to the network conditions has occurred that may justify a switch from the IP data bearer to the non-IP data bearer. For example, a failure to receive a registration update from the IoT device can indicate that the IoT device has insufficient network connectivity (e.g., due to a lack of coverage or large amounts of congestion) to communicate with the LwM2M server using the IP data bearer. Alternatively, the lack of a registration update message from the IoT device can indicate that the IoT device intends to de-register from the LwM2M server (e.g., due to the device powering off, sleeping, or entering an idle mode).

The MONTE events can be received from a SCEF/NEF of the network. The MONTE events can relate to the connectivity of the IoT device with the network and thus similarly indicate that a change in the network has occurred that makes IP communication more expensive or less reliable. The MONTE events can include a loss of connectivity event indicating that the IoT client device has detached from a network on which it was communicating with the LwM2M server or that there has been no communication between the IoT client device and the network for a period of time; a communication failure event indicating a failure with the IoT client device’s RAN connection or a failure with the IoT client device’s Non-Access Stratum (NAS) connection; a UE reachability event indicating that the IoT client device has transitioned from an ECM-CONNECTED mode to an ECM-IDLE mode or that the IoT client device has transitioned from the ECM-IDLE mode to the ECM-CONNECTED mode; an availability after DDN failure event indicating that the IoT client device has communicated with a network on which it was communicating with the LwM2M server after DL data failed to be delivered to the IoT client device; a roaming status event indicating that the IoT client device is on a roaming network; a location reporting event indicating that a location of the IoT client device has changed by more than a threshold amount for event reporting; or a PDN connectivity event indicating that the status of a PDN to which the IoT device was or is connected to has changed. In aspects, any one of the MONTE events can satisfy the first condition. Alternatively, multiple MONTE events or a particular combination of MONTE events may be needed to satisfy the first condition.

At 706, and in response to the first condition being satisfied, it is determined whether a second condition is satisfied to switch from the IP data bearer to the non-IP data bearer. Network or device data can be analyzed to determine if the second condition is satisfied. For example, signal strength data can be received to determine if the signal strength of the IoT device’s connection to the network is below a signal strength threshold. If so, the IoT device may have an insufficiently strong connection to the network to efficiently and effectively communicate using the IP data bearer. Accordingly, the signal strength of the IoT device’s connection to the network being below the signal strength threshold can satisfy the second condition to switch from the IP data bearer to the non-IP data bearer. The signal strength data can be received using an LwM2M object. For example, the signal strength data can be retrieved from a connectivity monitoring LwM2M object (Object ID: 4) of the IoT device or any other LwM2M object.

Alternatively or additionally, previously failed communications (e.g., DTLS) by the IoT device can indicate that the network is insufficient to support IP-based communication (e.g., due to a lack of coverage or congestion on the network) and thus that a switch to the non-IP data bearer is appropriate. To determine if a communication from the IoT device has previously failed to be completed, communication logs of the network can be checked. The communication logs can come from any node of the network or application server used to monitor network communications. In aspects, if a threshold number of communication failures has occurred within a preceding period of time, the second condition can be triggered to switch from the IP data bearer to the non-IP data bearer. In doing so, communications between the IoT device and the LwM2M can be more reliably completed using the non-IP data bearer.

In other cases, the second condition can be triggered based solely off of the MONTE events. For example, if a loss of connectivity event or a communication failure event is received, the second condition to switch from the IP data bearer to the non-IP data bearer can be satisfied. In these cases, the MONTE events themselves can indicate network conditions that are suitable for non-IP-based communication. In other cases, the second condition can be triggered by any other MONTE event or a combination of any other MONTE events.

At 708, and in response to determining that the second condition is satisfied, a communication can be transmitted to the IoT device to cause the IoT device to reregister with the LwM2M server using the non-IP data bearer. The communication can be a request to update an LwM2M object (e.g., the APN connection profile LwM2M object) to reflect the non-IP data bearer as an active data bearer to be used in subsequent communications. The communication can update the LwM2M object without interaction from the device or trigger a request for the IoT device to update the LwM2M object. In some cases, the communication itself may cause the IoT device to reregister with the LwM2M server even if no communication with the server was immediately needed. In other cases, the IoT device will wait to communicate with the LwM2M server until a communication with the server is planned, and that communication will reregister the IoT device using the non-IP data bearer.

In some cases, the IoT device is deregistered after the first condition is satisfied (e.g., due to an expiry of the registration lifetime, a MONTE event, or any other trigger to de-register the IoT device). Thus, the communication to cause the IoT device to switch from the IP data bearer to the non-IP data bearer can be transmitted only after the IoT device reregisters with the LwM2M server. In other cases, the registration of the IoT device can be maintained, even if the first condition or second condition is met, until the communication to cause the IoT device to switch from the IP data bearer to the non-IP data bearer is transmitted. In aspects, the LwM2M server can de-register the IoT device after transmitting the communication to cause the switch from the IP data bearer to the non-IP data bearer to allow for a reregistration to occur using the non-IP data bearer. In yet other aspects, the reregistration using the non-IP data bearer can update and change the current registration using the IP data bearer maintained by the LwM2M server.

At 710, the IoT device can be registered with the LwM2M server such that communication between the IoT device and the LwM2M server takes place over the non-IP data bearer. The IoT device can be registered in response to a registration request from the IoT device. The registration request can utilize the non-IP data bearer to reach the LwM2M server. The registration request can similarly indicate that the registration is to be associated with the non-IP data bearer. In response to the registration, the IoT device and the LwM2M server can communicate on the non-IP data bearer (e.g., to communicate sensor and control data). The registration can be maintained in accordance with the old registration lifetime or a new registration lifetime indicated in the registration request.

At 712, it is determined if a third condition sufficient to trigger a switch from the non-IP data bearer to the IP data bearer is satisfied. In aspects, the third condition can be satisfied by the reception of a MONTE event that indicates that IP-based communication is appropriate. For example, a PDN connectivity event that indicates that the IoT device has added a new PDN can indicate that sufficient network resources are now available for IP-based communication. Thus, the PDN connectivity event can trigger a switch to the IP data bearer. In yet other aspects, any other MONTE event or combination of MONTE events can trigger a switch to the IP data bearer.

Alternatively or additionally, the third condition can be satisfied when it is determined that the IoT device is to operate using IP-based communication at predetermined intervals. For example, the IoT device can be set to operate using IP-based communication during a set period of time. The set period of time can correspond to a period of time in which large amount of data is expected to be communicated by the IoT device. Thus, IP-based communication may be appropriate during this period of time due to the improved communication capabilities of IP-based communication. Accordingly, when the current time is within the set period of time or the current time is within a predetermined amount of time before the set period of time, the third condition to switch from the non-IP data bearer to the IP data bearer can be satisfied.

In yet other aspects, the third condition can be satisfied when a specific type of communication is transmitted between the IoT device and the LwM2M server. For example, the LwM2M server can detect when data that requires a high bandwidth or low latency is being communicated (e.g., live video data, real-time control signaling, and so on) and trigger a switch to the IP data bearer for this communication.

At 714, and in response to determining that the third condition is satisfied to trigger a switch from the non-IP data bearer to the IP data bearer, a communication can be transmitted to the IoT device to trigger the IoT device to switch from the non-IP data bearer to the IP data bearer. The communication can be similar to the communication at 708 but to switch to the IP data bearer instead of to the non-IP data bearer. Thus, the communication can update, or cause the IoT device to update, the APN connection profile LwM2M object to indicate the IP data bearer. In response to the communication, the IoT device can reregister with the LwM2M server using the IP data bearer, as discussed at 702, such that future communication between the IoT device and the LwM2M server take place over the IP data bearer.

### Computer System

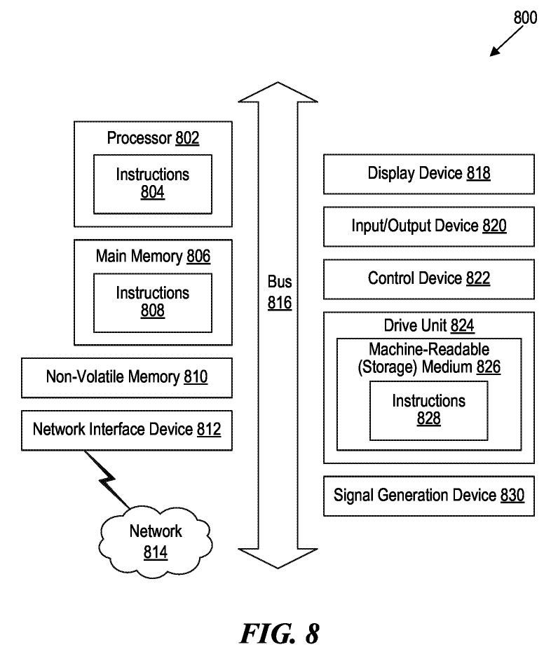

FIG. 8 is a block diagram that illustrates an example of a computing system 800 in which at least some operations described herein can be implemented. As shown, the computing system 800 can include one or more processors 802, main memory 806, non-volatile memory 810, a network interface device 812, a display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computing system 800 is intended to illustrate a hardware device on which components illustrated or described relative to the examples of the figures and any other components described in this specification can be implemented.

The computing system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 800. In some implementations, the computing system 800 can be an embedded computing system, a system-on-chip (SOC), a single-board computing (SBC) system, or a distributed system such as a mesh of computing systems, or it can include one or more cloud components in one or more networks. Where appropriate, one or more computing systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable (storage) medium 826) can be local, remote, or distributed. Although shown as a single medium, the machine-readable (storage) medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable (storage) medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
receiving, from an Internet-of-Things (IoT) client device, at a Lightweight Machine-to-Machine (LwM2M) server, and using an IP data bearer, a first registration request to register the IoT client device with the LwM2M server,
wherein the first registration request indicates that the IoT client device and the LwM2M server are to communicate using the IP data bearer,
wherein the first registration request includes a lifetime registration period in which the registration of the IoT client device is to be updated by a communication from the IoT client device to maintain the registration of the IoT client device;
in response to receiving the first registration request, registering the IoT client device with the LwM2M server such that communication between the IoT client device and the LwM2M server takes place over the IP data bearer;
determining that the LwM2M server does not receive the communication from the IoT client device to maintain the registration of the IoT client device within the lifetime registration period;
in response to determining that the LwM2M server does not receive the communication to maintain the registration of the IoT client device within the lifetime registration period, determining, based on an LwM2M object registered to the IoT client device or a Monitoring Events (MONTE) event associated with the IoT client device, that a condition is satisfied to switch from the IP data bearer to a non-IP data bearer;
in response to determining that the condition is satisfied, transmitting, to the IoT client device, a request for the IoT client device to attempt to register the IoT client device with the LwM2M server using the non-IP data bearer;
receiving, from the IoT client device, at the LwM2M server, and using the non-IP data bearer, a second registration request for the IoT client device to register the IoT client device with the LwM2M server,
wherein the second registration request indicates that the IoT client device and the LwM2M server are to communicate using the non-IP data bearer; and
in response to receiving the second registration request, registering the IoT client device with the LwM2M server such that communication between the IoT client device and the LwM2M server takes place over the non-IP data bearer.

2. The method of claim 1, further comprising:
in response to determining that the LwM2M server does not receive the communication to maintain the registration of the IoT client device within the lifetime registration period, deregistering the IoT client device from the LwM2M server; and
receiving a third registration request to register the IoT client device with the LwM2M server using the IP data bearer,
wherein the request for the IoT client device to attempt to register the IoT client device with the LwM2M server using the non-IP data bearer is transmitted in response to receiving the third registration request.

3. The method of claim 1, further comprising:
in response to determining that the LwM2M server does not receive the communication to maintain the registration of the IoT client device within the lifetime registration period, receiving an indication of one or more previous Datagram Transport Layer Security (DTLS) communication failures between the IoT client device and the LwM2M server; and
determining that the condition to switch from the IP data bearer to a non-IP data bearer is satisfied based on receiving the indication of the one or more previous DTLS communication failures.

4. The method of claim 1, further comprising:
in response to determining that the LwM2M server does not receive the communication to maintain the registration of the IoT client device within the lifetime registration period, receiving a resource of the LwM2M object registered to the IoT client device, the resource indicating a signal strength between the IoT client device and a network on which the IoT client device is communicating with the LwM2M server; and
determining that the condition to switch from the IP data bearer to a non-IP data bearer is satisfied based on the signal strength between the IoT client device and the network on which the IoT client device is communicating being insufficient to satisfy a network signal strength criteria.

5. The method of claim 1, wherein the request for the IoT client device to attempt to register the IoT client device with the LwM2M server using the non-IP data bearer comprises a request to update an additional LwM2M object registered to the IoT client device indicating an access point name (APN) connection profile of the IoT client device to correspond to the non-IP data bearer.

6. The method of claim 1, further comprising:
receiving, at the LwM2M server, a notification indicating that the MONTE event has occurred,
wherein the MONTE event comprises a loss of connectivity event, a communication failure event, a user equipment reachability event, an availability after downlink data notification (DDN) failure event, a roaming status event, or a location reporting event; and
determining that the condition to switch from the IP data bearer to a non-IP data bearer is satisfied based on the reception of the notification indicating that the MONTE event has occurred.

7. A Lightweight Machine-to-Machine (LwM2M) server comprising:
at least one hardware processor; and
at least one non-transitory memory storing instructions that, when executed by the at least one hardware processor, cause the LwM2M server to:
receive, from an Internet-of-Things (IoT) client device and using an Internet-Protocol (IP) data bearer, a first registration request to register the IoT client device with the LwM2M server;
in response to receiving the first registration request, register the IoT client device with the LwM2M server such that communication between the IoT client device and the LwM2M server takes place over the IP data bearer;
receive a notification indicating that a Monitoring Event (MONTE) event associated with the IoT client device has occurred;
in response to receiving the notification indicating the MONTE event, determine, based on the MONTE event, that a condition is satisfied to switch from the IP data bearer to a non-IP data bearer;
in response to determining that the condition is satisfied, transmit, to the IoT client device, a communication to cause the IoT client device to register with the LwM2M server using the non-IP data bearer;
receive, from the IoT client device and using the non-IP data bearer, a second registration request for the IoT client device to register the IoT client device with the LwM2M server; and
in response to receiving the second registration request, register the IoT client device with the LwM2M server such that communication between the IoT client device and the LwM2M server takes place over the non-IP data bearer.

8. The LwM2M server of claim 7, wherein the instructions further cause the LwM2M server to:
in response to receiving the notification of the MONTE event, receive an indication of one or more previous Datagram Transport Layer Security (DTLS) communication failures between the IoT client device and the LwM2M server; and
determine that the condition to switch from the IP data bearer to a non-IP data bearer is satisfied based on receiving the indication of the one or more previous DTLS communication failures.

9. The LwM2M server of claim 7, wherein the instructions further cause the LwM2M server to:
in response to determining that the LwM2M server does not receive the communication to maintain the registration of the IoT client device within a lifetime registration period, receiving a resource of an LwM2M object registered to the IoT client device, the resource indicating a signal strength between the IoT client device and a network on which the IoT client device is communicating with the LwM2M server; and
determining that the condition to switch from the IP data bearer to a non-IP data bearer is satisfied based on the signal strength between the IoT client device and the network on which the IoT client device is communicating being insufficient to satisfy a network signal strength criteria.

10. The LwM2M server of claim 7, wherein the communication to cause the IoT client device to register with the LwM2M server using the non-IP data bearer comprises a request to update an LwM2M object registered to the IoT client device indicating an access point name (APN) connection profile of the IoT client device to correspond to the non-IP data bearer.

11. The LwM2M server of claim 7, wherein the MONTE event comprises a loss of connectivity event indicating that the IoT client device has detached from a network on which it was communicating with the LwM2M server or that there has been no communication between the IoT client device and the network for a period of time.

12. The LwM2M server of claim 7, wherein the MONTE event comprises a communication failure event indicating a failure with the IoT client device’s Radio Access Network (RAN) connection or a failure with the IoT client device’s Non-Access Stratum (NAS) connection.

13. The LwM2M server of claim 7, wherein the MONTE event comprises a user equipment reachability event indicating that the IoT client device has transitioned from an ECM-CONNECTED mode to an ECM-IDLE mode or that the IoT client device has transitioned from the ECM-IDLE mode to the ECM-CONNECTED mode.

14. The LwM2M server of claim 7, wherein the MONTE event comprises an availability after downlink data notification (DDN) failure event indicating that the IoT client device has communicated with a network on which it was communicating with the LwM2M server after downlink data failed to be delivered to the IoT client device.

15. The LwM2M server of claim 7, wherein the MONTE event comprises a roaming status event indicating that the IoT client device is on a roaming network.

16. The LwM2M server of claim 7, wherein the MONTE event comprises a location reporting event indicating that a location of the IoT client device has changed by more than a threshold amount for event reporting.

17. The LwM2M server of claim 7, wherein the LwM2M server is further caused to:
in response to registering the IoT client device with the LwM2M server such that communication between the IoT client device and the LwM2M server takes place over the non-IP data bearer, receive a notification indicating that an additional MONTE event associated with the IoT client device has occurred;
in response to receiving the notification indicating the additional MONTE event, determine, based on the additional MONTE event, that an additional condition is satisfied to switch from the non-IP data bearer to the IP data bearer; and
in response to determining that the additional condition is satisfied, transmit, to the IoT client device, a communication to cause the IoT client device to register with the LwM2M server using the IP data bearer.

18. The LwM2M server of claim 17, wherein the additional MONTE event comprises a Packet Data Network (PDN) connectivity event indicating that the IoT device has connected to a PDN.

19. The LwM2M server of claim 7, wherein the LwM2M server is further caused to:
in response to registering the IoT client device with the LwM2M server such that communication between the IoT client device and the LwM2M server takes place over the non-IP data bearer, transmit, to the IoT client device, a communication to cause the IoT client device to register with the LwM2M server using the IP data bearer based on a current time or upcoming time being within a predetermined time period in which the IoT client device is to communicate using the IP data bearer.

20. At least one non-transitory, computer-readable storage medium storing instructions, which, when executed by at least one data processor of a system, cause the system to:
receive, from an Internet-of-Things (IoT) client device and using an Internet-Protocol (IP) data bearer, a first registration request to register the IoT client device with a LwM2M server;
in response to receiving the first registration request, register the IoT client device with the LwM2M server such that communication between the IoT client device and the LwM2M server takes place over the IP data bearer;
determine that a first condition has been satisfied, the first condition comprising:
reception of a Monitoring Event (MONTE) event, or
a failure to receive a registration update message within a period of time corresponding to a lifetime of the registration of the IoT client device;
in response to determining that the first condition has been satisfied, determine, based on an LwM2M object registered to the IoT client device, that a second condition is satisfied to switch from the IP data bearer to a non-IP data bearer; and
in response to determining that the second condition is satisfied, transmit, to the IoT client device, a communication to cause the IoT client device to register with the LwM2M server using the non-IP data bearer.
